(19) United States
(12) Patent Application Publication
(10) Pub. No.: US 2019/0373816 A1
(43) Pub. Date: Dec. 12, 2019

(54) DEVICE AND METHOD FOR INTRODUCING A HIGH VOLTAGE INTO A SUBSTRATE WHICH COMPRISES BIOLOGICAL MATERIAL

(71) Applicant: Zasso GmbH, Aachen (DE)

(72) Inventors: Matthias EBERIUS, Wuerselen (DE); Sergio DE ANDRADE COUTINHO FILHO, Indaiatuba (BR); Dirk VANDENHIRTZ, Aachen-Kornelimuenster (DE)

(73) Assignee: Zasso GmbH, Aachen (DE)

(21) Appl. No.: 16/463,900

(22) PCT Filed: Nov. 27, 2017
(86) PCT No.: PCT/DE2017/000403

§ 371 Date: Jun. 3, 2019

(30) Foreign Application Priority Data
Nov. 25, 2016 (DE) 10 2016 014 057.7

(51) Int. Cl. A01G 7/04; A01D 82/02; H01R 3/00

(52) U.S. Cl. CPC A01G 7/04; A01B 69/008; H01R 3/00; A01D 82/02

(57) ABSTRACT

In a device and method for introducing high voltage into a substrate containing biological material, an applicator module having two or more applicators with simultaneously differently polarized applicators is used, through which the electrical high voltage is delivered in metered quantities to change the substrate. Different variants make it possible to introduce the high voltage into the substrate in controlled manner and selectively.

The invention relates to a device and method for introducing high voltage into a substrate which contains biological material.

The standard method presented in many patents for using electrical high voltage (tension with at least 1,000 V) consists in killing plants that are defined as weeds. In this context, electrical current is introduced into the foliage of the weed with an applicator with the objective of killing it including the roots. In order to close the circuit through the leaf, root and ground, contact is made with the ground using a second applicator. Both applicators may also contact the leaves of different plants, and the destruction of both plants is then brought about by closing the circuit through the roots.

Unlike the preceding method, in the method described here, which will be referred to in the following as the ElektroBioMod method, target-specific applicators are used for transmitting electrical high voltage and energy, not for the purpose of killing plants as weeds, but for contacting cultivated plants, parts of cultivated plants, other organisms or parts of organisms selectively at certain parts of the organism with high voltage in order to systematically achieve desired effects not intended to kill weeds, but rather to induce a specific structural change in them or parts functionally associated therewith to which the high voltage is applied. The consequence of this structural change in the substrate is the agronomic stimulation of the cultivated plants, their yield, harvest quality, the quality of the agricultural by-products or the usability of treated materials in subsequent process steps.

This differing objective according to the invention demands a novel applicator type and a way to control the system for metered delivery which has the following basic properties and is then of variously designed geometry corresponding to the respective individual applications in order to achieve the delivery of electrical high voltage appropriate to the objective.

The applicator units, which are each implemented in pairs or multiples, must be arranged in a defined relationship and usually next to one another so that they are effective only in the desired area, which is often not located in the foliage area which draws current well, but very frequently on the better insulating trunks and/or fresh branches located there. In most cases, a non-specific return circuit of the current through the ground is not possible because in most cases the roots must not be affected. The applicators must be well insulated from each other. The output of the individual applicator units must be deliverable in precisely measured quantities and limited, and consequently must not be influenced by contacts and resistances from other objects coming into contact with the system as a whole. It must be possible to operate a large number of individual applicators in parallel, so that correspondingly high total area outputs can be made available to the system.

If the trunk is sufficiently conductive, the whole plant is structurally changed in the area of application, but in the case of woody trunks the current only flows through and changes the fresh, unlignified water sprouts, side branches or other vegetation in the same position directly on the trunk until the surface conductivity of the better insulated trunk is altered intentionally with abrasive applicators.

The device serves as an electrophysical alternative method for non-systemic broadleaf herbicides and other herbicides with non-systemic action and sprout inhibiting agents whose use is subject to increasing prohibitions, and as an electrophysical alternative to mechanical methods which do not produce adequate results by the nature of their function or are too expensive or energy-intensive.

In order to deliver the power, one control and transformation module is used for each applicator unit, that is to say two applicators or multiple applicators, on each mounting unit with closely co-located individual applicators, which module is designed to deliver high voltage in a range from 1,000 to 40,000 V and from 10 to 10,000 W of power. The respective working range is adjusted automatically in accordance with an implemented work characteristic depending on the substrate resistance, wherein to the extent possible not a single working point but a working range with the highest possible output is selected by processor-controlled power-optimisation. The processor controller also allows sensor-based or other data-driven control influences up to pattern detection and artificial intelligence for parameter optimisation.

In order to solve the object, a base applicator consisting of two or more adjacent individual applicators with simultaneously opposite polarities is used. These applicator units may be powered by alternating current (phase to 0 or two opposite phases) or direct current (+, −, wherein one pole has near-earth absolute potential).

The applicator units with opposite polarities are separated from each other by an insulating intermediate layer 0.5 to 10 cm wide. This intermediate layer may have similar mechanical properties to the applicators with regard to flexibility and durability, for example. The task of the intermediate layer is to prevent direct flashovers between the applicators by means of labyrinthine separation and to keep plant parts out of the intermediate area, so that no bridging short circuits occur inside the applicator. For this purpose, densely arranged plastic bristles, plastic straps, plastic ridges or elastic plastic plates are used which have the same shape and size as is used for the metal applicators. The units may then be expanded by adding further applicators with alternating polarity. Depending on the application, laminated circular brushes with and without a drive unit may also be used, and the orientation of the units is adapted to the respective plants. Only with a well defined substrate thickness are the adjacent poles replaced with opposing poles.

The object of the device is to improve the related art significantly for the purposes of a number of applications. This involves replacing more expensive and more time-consuming and energy-intensive mechanical methods. But in particular, chemical methods that lead to a partial destructuring of individual plant parts are replaced with a non-chemical, non-toxic method which leaves no residue.

A first area of application is whole plant drying and conversion into biogas. If biomass is to be converted into process gas, a water content from 10-15% is necessary, such as is naturally present in straw, whereas all other biomass materials have to predried separately or at the start of the gasification process, with considerable expenditure of energy. This process significantly reduces the efficiency of the methods. At the same time, the high moisture content also presents storage problems and an undesirable degradation of the biomass there. Previously, the material had to be cut, although it then lies more densely and dries out poorly, particularly in unstable weather conditions, or begins to rot. Since this means that it is therefore technically not possible to dry biomass in the field, until now the material was used in biogas plants with liquid gasification by bacteria, which however raises significant problems and entails digestion of the cellulose, for example, and is less efficient overall.

The state of the art regarding selective ripening: For harvesting very many arable crop types, it is important that ripening is even, as much moisture as possible is removed from the crops and that the green vegetation parts of the crop and any weeds present are largely dried out. If this is not the case, harvesting becomes massively more difficult and more expensive, results in a lower yield, the ability of the crop to be stored is impaired, and the harvesting process takes longer. In the past, this problem—which is often weather-related—was most often solved by spraying the plants with chemical agents (desiccation herbicides) to dry them out. The agents used can leave residues behind in the crop and the environment, and in some application cases bans or strict regulation thereof are becoming more widespread.

In order to encourage microbial recovery in the plants, many digestion processes are available which are intended to render the plants more easily reusable after mechanical shredding or in the liquid phase by enzymatic or physical methods (grinding, ultrasound, etc.). Other options are the expensive extraction of primary components, fermentation, microbial removal of secondary components, e.g., fibre recovery (flax, hemp, etc.), fermentation optimisation.

The ElektroBioMod method provides the capability of initiating internal cell breakdown with relatively low energy input and without any additional medium or agents by introducing targeted energy, thereby rendering subsequent mechanical or other digestion steps considerably easier and more effective, and because of its cellular effect strongly encouraging bacterial access and hydrolysis.

The use of large quantities of fungicides and copper preparations to minimise plant diseases such as fungal infections has a huge impact on the environment, which however is often essential in order to combat downy mildew. The infected vine leaves and severed branches remain in the vineyard, and the spores which survive the winter can quickly cause re-infection, particularly as a result of splash water and the spread of dust from the exposed soil (weed control and digging in of vine leaves).

Treating the vine foliage which has been cut off immediately after cutting during and after the season reduces the formation of resting spores, firstly because the leaves quickly give off any remaining tartaric acid due to cell destruction according to the ElektroBioMod method and for the same reason they also decay and decompose faster, which means their availability as a host for the fungus is reduced and more antagonists come into contact with the fungus on the leaves or in the humus substrate.

The advantages of the ElektroBioMod method reside in that it interrupts contamination chains through a reduction of the use of herbicides, fungicides, and increased carbon sequestration in the soil.

Another area of use is water sprout removal. Lignified plants and trees, and particularly grafted plants such as many grapevines for example, but also roadside trees have considerable growth of undesirable side shoots, usually called water sprouts. Ideally, these must simply be removed gently and with minimum injury to the plant. Besides mechanical pruning, there are methods with brushes and chemical processing with defoliants in low concentrations. The chemical methods require a great deal of experience and exact dosing, which is often difficult, more and more chemical agents are being restricted or banned, mechanical pruning is time-consuming and expensive, the mechanical removal of the water sprouts with brushes causes undesirable injuries, which then lead to infections.

With the ElektroBioMod method, a long-bristle brush (bristle length 100-400 mm) with smooth or only slightly roughened, loosely distributed electrically conductive bristles (preferably polymer) are passed over the trunk, preferably at an angle of least 90° to the trunk. The brush rotates upwards from the bottom on the side of the trunk so that the water sprouts are not ripped off. In the simple version, the water sprouts are touched with only one pole. The very low strength current drains through the much thicker trunk without doing any damage. In the two-pole version, the middle of the brush is passed upwards/along the trunk. In this process, the bottom ends of the water sprouts are exposed to the opposite polarity to the polarity applied to the upper areas. This reduces the current flow in the main trunk to an absolute minimum.

The water sprouts remain on the trunk and dry up. No open wounds are created on the trunk and no chemicals have to be used. The method can be automated and may be performed efficiently with autonomous devices. Depending on the nature of the water sprouts, an un-modified vine stem cleaner is used and only has to move further upwards.

Another area of use relates to selective stressing and root reduction: In many cases, it is possible to divert an increasing proportion of the photosynthesis output of plants to the harvest elements by pruning the roots and shoots. This is normally done by usually mechanical pruning of roots to reduce the growth of shoots and increase the fruit portion. The loss of some of its roots induces a stress reaction in the plant, which either triggers a mild drought stress or infestation stress reaction directly, or is interpreted indirectly as such by the plant. This is particularly effective when the roots are pruned without shoot reduction. But shoot reduction too induces increased investment in the fruit for many plants.

According to the invention, electrical current is introduced into the intermediate areas of the cultivated plants on the surface or via depth electrodes in such a way that some of the roots of the plant die off or are at least damaged. Many plants interpret this as stress, which inhibits cellulose production (more branches, leaves) generally results in increased investment in fruit and sugar. In this way, for example, the sugar content in sugar cane can be raised, or the lengthwise growth of fruit tree branches may be limited, benefiting the fruit and the water consumption.

The method according to the invention involves at least substantially less interference with the soil structure, if any, and often reduces competition from weeds at the same time. All biological and technical disadvantages associated with soil disruption are avoided. In this way, for example, it is also much easier to avoid damaging irrigation systems, because the ground area undergoes less mechanical intervention, or none at all.

Another area of use is the killing of harmful organism stages in plant parts: In commercial crop growing, the pests can often be dealt with using systemic insecticides. But this entails considerable expense, and in the private sector and the public sector (roadside trees etc.) it is prohibited or very strictly regulated. Accordingly, often the only remaining option is to isolate the fallen leaves that contain the hibernating organism stages as completely as possible and burn them. Other forms of waste disposal from domestic garbage to composting very often result in the pathogens being propagated further.

According to the invention, the fallen leaves are treated electrophysically immediately after they have been collected, and the pest stages are eliminated thereby. For this, the leaves may be exposed to high-frequency high voltage by passing them between the two electrodes for a specified residence time on a continuous or discontinuous conveyor system.

This treatment on site enables the infected leaves to be treated in groups of the same kind, which means they are treated more efficiently and do not have to be diverted on special paths afterwards for further reuse, and this in turn reduces logistical and disposal costs. Consequently, private individuals or other owners of the infected foliage may also be able to render them harmless by using the Electroherb technology, at considerably less expense than would be possible by disposal as domestic waste or special incineration. The foliage can then even remain at the site and be used as normal fertiliser.

In a first embodiment, applicator units touch the plants with both applicator polarities from the side and from the side just above the ground to interrupt the flow of water in the trunk. Depending on the plant, contact from one side may be sufficient or it may be necessary to touch as much of the circumference of the trunk as possible with a contacting or abrasively acting applicator (metal brush (stationary or rotating), scraping sheet metal ends or cutting metal) if the steles can only be reached directly from the outside and are to be damaged extensively (lignified structures).

The applicator units in the individual rows travel under guidance by a main transport module or autonomously with their own drive system and power supply. Besides the applicators described here, other applicators of different types or devices with physical/mechanical operating principles may be attached particularly in the region close to the ground.

Besides static units, i.e. units which function only by spring force or material resilience (rubber, plastic, metal as base), are flexible and otherwise immobile, the following actively moving applicator units may also be used:

Straight unit (brush/bar): After the signal indicating approach to the obstruction, the unit rotates actively and rapidly around the obstruction, if possible in contact with the obstruction, to return to its starting position with the leading tip facing outwards after brushing the entire region around the obstruction.

Tri-wing unit: This unit also rotates around the object in the same way as described for the straight unit, but with the advantage that a smaller rotation is needed, and the device may therefore be driven generally more quickly.

Two brushes arranged one above the other with horizontal axis of rotation and horizontal movement detect the trunk, also under the control of sensors in the lower region.

A sensor-controlled brush having one pole in the middle and the opposite pole in the peripheral area travels up the trunk under sensor control and in so doing contacts water sprouts and other more conductive branches on an effectively insulating trunk with electrical current, to render them barren.

Depending on the application case, it may be appropriate to partially damage the roots in order to trigger certain responses in the plants. Then, the same applicators as in the device described previously are used, the only difference being that the trunk is only contacted by one pole and in a smaller area, and this only disrupts some of the water-bearing structures. Optionally, a soil applicator acting on the surface or cutting into the topsoil may be used, or the electrical circuit is closed by a nearby plant. In this case, the output must be limited according to the specific plant by use of individually controlled power supply units.

Various embodiments are represented in the drawing and will be described in greater detail in the following text. In the drawing:

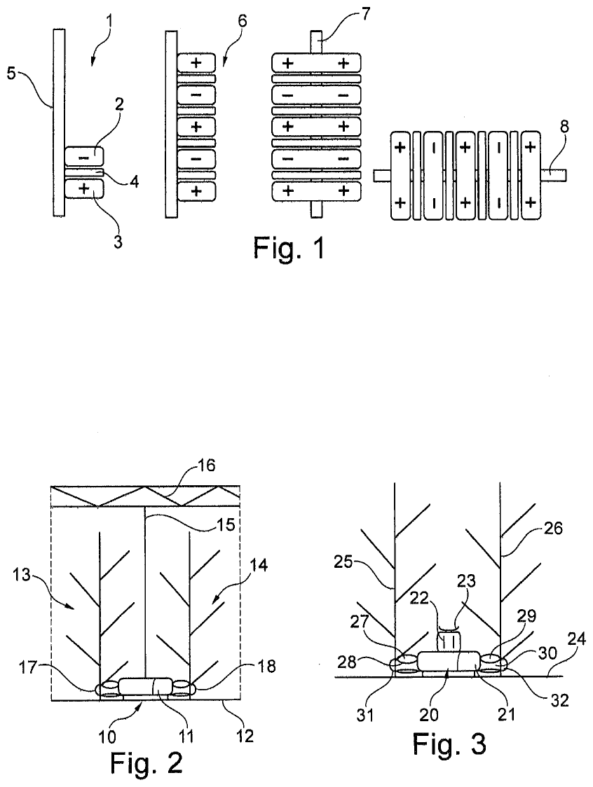

FIG. 1 shows various applicator modules on applicator carriers,

FIG. 2 is a diagrammatic representation of a single applicator module,

FIG. 3 is a diagrammatic representation of a single, self-propelled applicator module,

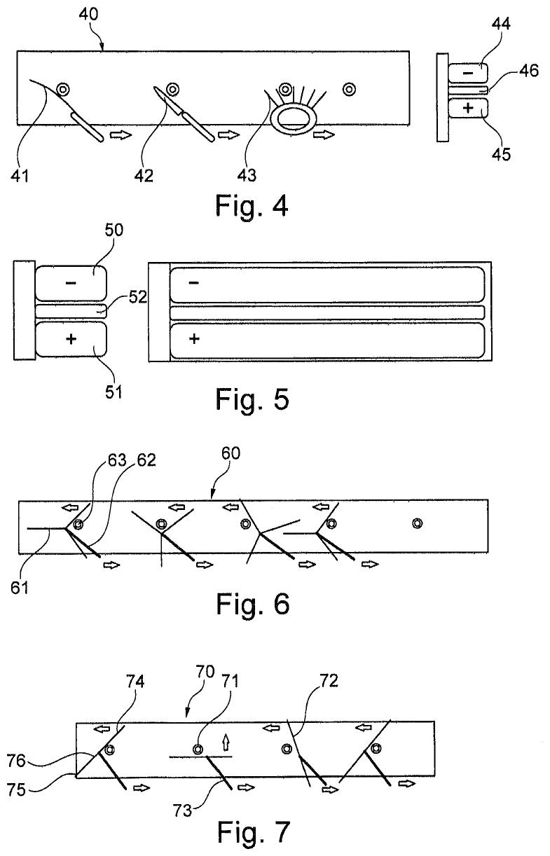

FIG. 4 is a diagrammatic representation of an arrangement of the single applicators,

FIG. 5 is a diagrammatic cross-section through statically attached applicators,

FIG. 6 is a diagrammatic representation of the dynamic motion of an applicator assembly with three arms,

FIG. 7 is a diagrammatic representation of the dynamic motion of an applicator assembly with two arms,

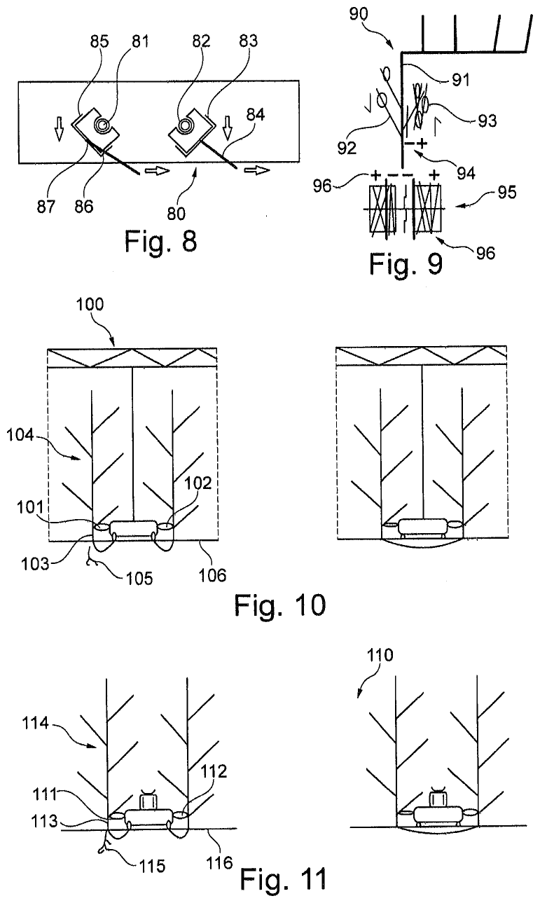

FIG. 8 is a diagrammatic representation of the dynamic motion of an applicator assembly with brushes,

FIG. 9 is a diagrammatic representation of the treatment of a plant with water sprouts,

FIG. 10 is a diagrammatic representation of an embodiment similar to the embodiment shown in FIG. 2,

FIG. 11 is a diagrammatic representation of an embodiment similar to the embodiment shown in FIG. 3,

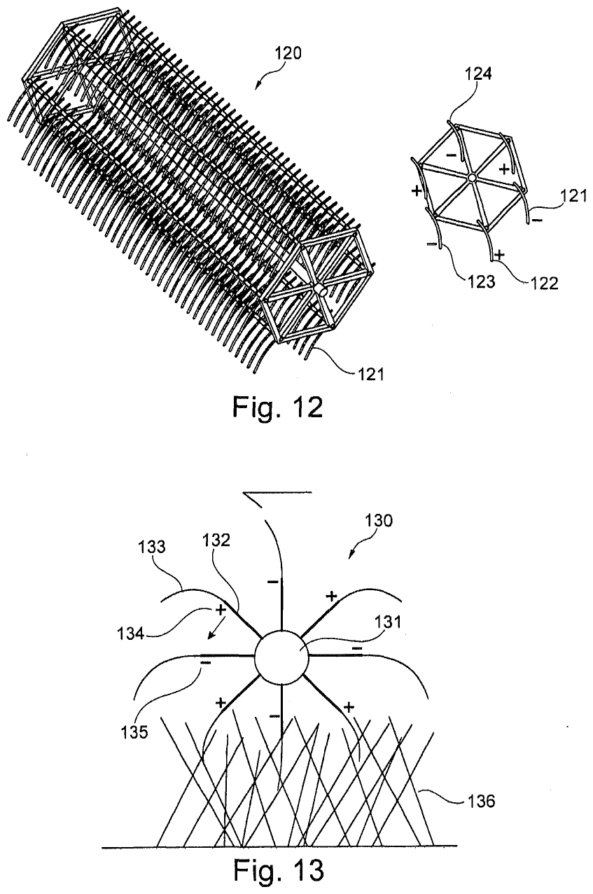

FIG. 12 shows an applicator in the form of a drum,

FIG. 13 is a diagrammatic representation of a drum-like applicator in use,

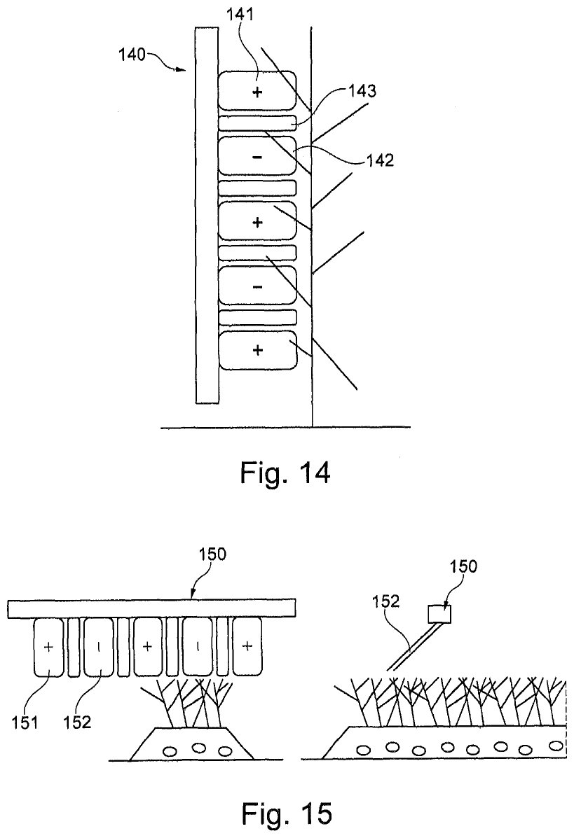

FIG. 14 is a diagrammatic representation of an applicator assembly with alternating polarities in use,

FIG. 15 is a diagrammatic representation of a downward working applicator with strap applicators arranged side by side in use,

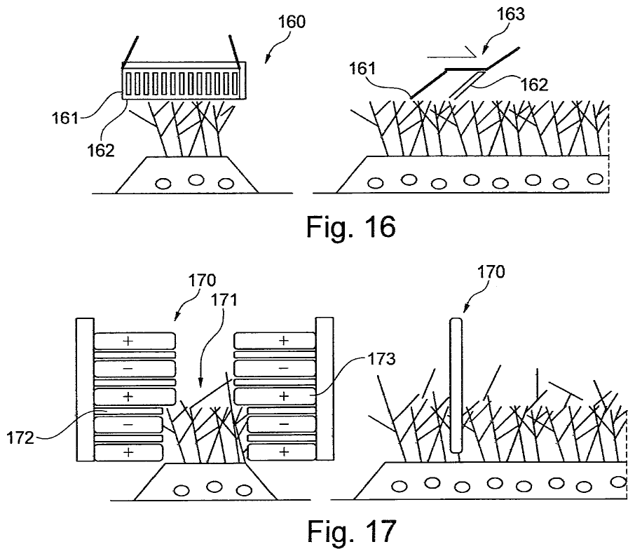

FIG. 16 is a diagrammatic representation of a top acting applicator with strap applicators arranged one behind the other in use,

FIG. 17 is a diagrammatic representation of a side acting applicator with strap applicators arranged one behind the other in use,

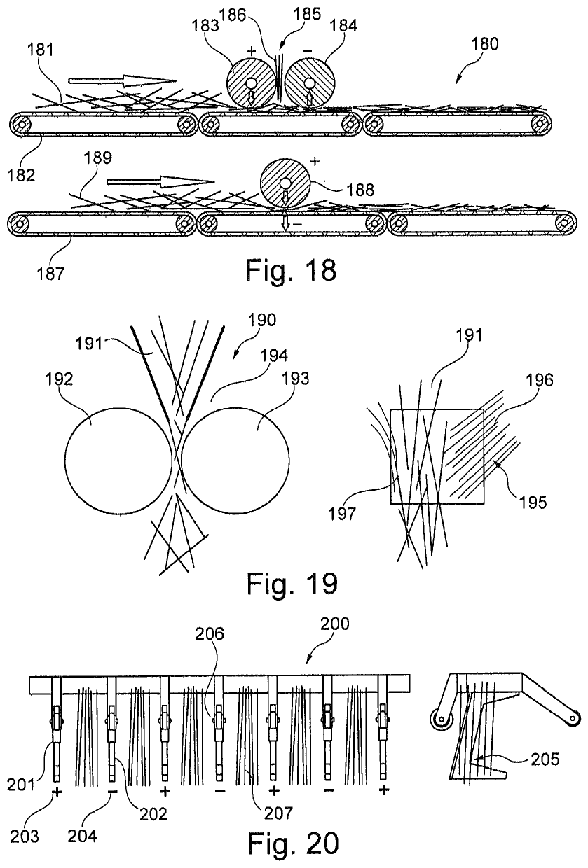

FIG. 18 is a diagrammatic representation of a belt feed system,

FIG. 19 is a diagrammatic representation of another embodiment of a belt feed system, and

FIG. 20 is a diagrammatic representation of an applicator assembly for compacted substrate layers.

FIG. 1 is a diagrammatic representation of the smallest unit of an applicator module 1 with two simultaneously oppositely polarised applicators 2, 3 (here identified with +/−) with an insulating intermediate layer 4 on an applicator carrier 5. The next diagram shows an alternating extension of a longer applicator series 6 and arrangement variants with applicators that are rotatable about a vertical axis 7 and a horizontal axis 8.

FIG. 2 is a diagrammatic representation of a preferred variant of a single applicator module 10 with installed high voltage transformation unit 11, which travels and brushes over the ground 12 between two rows of plants 13, 14. Module 10 is guided by a strut 15 with a pulling and power supply cable 16 (preferably normal voltage) which is towed over the field behind a mobile unit (e.g., a tractor). The plants on either side are touched with two or more (here two) applicators 17, 18 of different polarities which are arranged closely one on top of the other and conduct high voltage through a short section of the plant, changing it structurally. The applicators 17, 18 may be of different shapes and may be attached statically or dynamically.

FIG. 3 is a diagrammatic representation of a single, self-propelled applicator module 20, preferably with installed high voltage transformation unit 21, energy store 22 and navigation unit 23, which travels over the ground 24 between two rows of plants 25, 26. Module 20 is guided mechanically in the row with higher-level control via GPS. The plants on either side are touched with two or more (two are shown here) applicators 27, 28 and 29, 30 of different polarities which are arranged closely one on top of the other and conduct high voltage through a short section of the plant, changing it structurally there. This line is indicated symbolically with a semicircle 31, 32. The applicators may be of different shapes and may be attached statically or dynamically.

FIG. 4 is a diagrammatic representation of an arrangement of the single applicators in an applicator assembly 40 consisting of two different applicators arranged one above the other, shown here in plan view. The individual brushing applicators consist of elastic metal sheets or elastic plastic/rubber/metal composite units 41, flexible straps 42 or brush units 43 which are electrically conductive on the contact side. An insulating area 46 made from geometrically similar materials is installed between each of the applicator poles 44, 45 as insulation.

FIG. 5 is a diagrammatic representation of statically attached applicators in cross-section and from the front. The single applicators 50, 51 brushing along the plant may consist of brushes, flat wire rows, straight, curved or segmented metal sheets or passively or actively rotating circular brushes. An insulating area 52 of geometrically similar materials is installed between each of the applicator poles as insulation.

FIG. 6 is a diagrammatic representation of the dynamic motion of an applicator assembly 60 in plan view along a row of plants, the trunks of which are to be touched as extensively as possible. In this case, a three-wing applicator assembly 61 attached to a boom arm 62 rotates passively or actively following the contour of the trunk 63 and brushes almost the entire circumference thereof. The applicators are attached to both sides of all arms. If a ground applicator is also fitted on the underside of the arms, it may also control weeds on the ground at the same time in one work pass.

FIG. 7 is a diagrammatic representation of the dynamic motion of an applicator assembly 70 along a row of plants, each of which has a trunk 71, the trunks of which are to be touched as extensively as possible. In this case, a two-wing applicator assembly 72 attached to a boom arm 73 rotates actively following the contour of the trunk 71 and brushes almost the entire circumference thereof. Applicators 74, 75 are attached to both sides of the arm 76. If a ground applicator is also fitted on the underside of the arms, it may also control weeds on the ground at the same time in one work pass.

FIG. 8 is a diagrammatic representation of the dynamic motion of an applicator assembly 80 along a row of plants 81, 82, the trunks of which are to be touched as extensively as possible. In this case, an applicator assembly 80 consisting of soft, horizontally rotating brushes 83 and attached to a boom arm 84 actively follows the contour of the trunks of the plants 81, 82 and brushes almost the entire circumference thereof. The applicators 85, 86 are attached to one side of the arm 87.

FIG. 9 is a diagrammatic representation of a plant 90 with water sprouts 92 growing randomly on the trunk 91 which are to be atrophied. They are contacted via a brush 93 which is guided in an up and down motion in the external area close to the trunk mechanically or by sensors. The area of the brush 93 closest to the trunk has a pole 94 which is polarised close to the ground, while the area 95 farthest from the trunk consisting of insulating bristles 96 after an intermediate layer has the opposite polarity 96. Consequently, electric current only passes through the water sprouts.

FIG. 10 shows an embodiment 100 similar to the embodiment of FIG. 2, but in this case the applicators 101, 102 may have the same or different polarities and conduct the high voltage through a short section 103 of the plant 104, changing its structure, or follow a path over a short section of the ground 106 to the root 105.

FIG. 11 shows an embodiment 110 similar to the embodiment of FIG. 3, in which the applicators 111, 112 may have the same or different polarities and conduct the high voltage through a short section 113 of the plant 114, changing its structure, or follow a path over a short section of the ground 116 to the root 115.

FIG. 12 shows an applicator in the form of a drum which touches the densely matted plants from above with both poles at spaced intervals to reduce the water flow in the shoot area, where harvest material for ripening is also located and must be touched and shaken as little as possible so that, for example, seed contents which are already ripe do not fall to the ground and become lost. The current flow takes place in the matter shoot sections. Star-shaped, fixed bristles with flexible ends may be used instead of a drum. Because of the large spaces between the applicators, insulation is not required.

Drum applicator 120 has a different polarity 122, 123 on hanging single contacts 121. In the embodiment shown, these single contacts 121 are curved, and are weighted at the top end 124 or brought into a favourable starting position for deep, low-friction insertion into the matted plant layer by spring force. Drum applicator 120 is rotated actively during the pass,

FIG. 13 is a diagrammatic representation of a drum-like applicator 130 with central rotation axle 131, rigid inside bristle carriers 132 fixed permanently to the rotation axle, and flexible, connected long bristles 133 of flat material with good electrical conductivity for lateral stabilisation with alternating polarities 134, 135. These flexible bristles 133 plunge into the plant substrate 136 and create cross-contacts, which change the plant material and cause it to dry out more quickly. This results in better ripening of the plant seeds as the upper stalk areas slowly shrivel up.

In a further embodiment of the apparatus, two or more quasilinear applicators with different or alternating polarities touch the same plant in as many places as possible above the ground to bring about the structural destruction of many cells without directing current to the roots or other subsurface organs. The application may be carried out either from above or from the side.

FIG. 14 is a diagrammatic representation of an applicator assembly 140 with alternating polarities 141, 142 and insulator regions 143 positioned between them, which apply high voltage electrical current to the full height of an entire plant with short conduction paths.

FIG. 15 is a diagrammatic representation of a top-acting applicator 150 having polarities 151, 152 that alternate within a small space in the direction of travel for treating leaf masses from above.

FIG. 16 is a diagrammatic representation of a top-acting applicator 160 having polarities 161, 162 that alternate within a small space in the direction of travel for treating leaf masses from above when the root organs must not be damaged (e.g. potatoes). Instead of strap applicators 163 with different polarities 161, 162 arranged one behind the other, brushes, or strap applicators with different polarities arranged side by side in the direction of travel may be used.

FIG. 17 is a diagrammatic representation of a side-acting applicator module 170 having applicators 172, 173 arranged laterally at the top and beside the plant 171. With high conductivity, the applicator 172, 173 brought into contact with the side of the plants may also come into contact with the topsoil, which does not represent a problem.

This improves biodegradability and encourages breakdown by bacteria, fungi and enzymes in the field or in biotechnological methods rapid drying of the leaf portions, in the case of ground crops such as potatoes, cereals, legumes for example.

In a further embodiment, the high voltage is introduced into isolated portions of diseased plants or into plants which have been sown to attract harmful organisms. This is carried out by means of rollers, conveyor belts etc. to structurally destroy the highly conductive structures in the plant sections very quickly. The highly conductive structures to be destroyed may be plant parts, fungi, eggs, caterpillars, snails, nematodes or bacteria. The horizontal feed with a conveyor belt serves either as a cantilever for the two applicator rollers, or the conveyor belt itself serves as applicator. In the case of vertical feed, the two applicator rollers are positioned opposite one another. In all cases, the narrowest areas between the applicators are permanently separated (horizontal double roller), or if there is no substrate in the device by an elastic, brush-like insulating layer to prevent flashovers.

In the case of compacted substrate layers, the applicators are drawn through the substrate in alternating polarities in form of a cutter blade, and the intermediate space in the areas that contain no substrate are held apart by a brush-like insulator.

FIG. 18 is a diagrammatic representation of a belt feed system 180 with cut substrate 181, which is transported under two applicator rollers 183, 184 by the insulating conveyor belt 182 as a counterbalance. The gap 185 between the applicator rollers 183, 184 is fitted with a sweeper-like insulating curtain 186. Alternatively, the conveyor belt 187 may be used as a second applicator. Then the gap between the two applicators, conveyor belt 187 and applicator roller 188 should each be sealed with an insulating sweeper (not shown) while substrate 189 is not present but the system is running.

FIG. 19 is a diagrammatic representation of a belt feed system 190 with cut substrate 191, which is transported under two applicator rollers 192, 193. The gap 194 between the applicator rollers 192, 193 is fitted with a sweeper-like insulating curtain 195. This makes it possible to keep the gap 194 between the two applicators 192, 193 that functions as an insulating curtain 195 closed with an insulating sweeper while substrate 191 is not present but the system is running. The view of the gap in FIG. 19 shows expanded sweeper bristles 196 on the right side and the deflection of the sweeper bristles 197 when substrate passes through on the left.

FIG. 20 is a diagrammatic representation of an applicator assembly 200 for compacted substrate layers through which it is drawn. The applicators 201, 202 with alternating polarities 203, 204 function as cutting blades 205, and intermediate space 206 in the areas where no substrate is present are kept apart by a brush-like insulator 207.

The result is a thorough structural destruction of the sequestered, treated plant material, improved control of plant diseases by deactivation of the pathogens, greater susceptibility to rapid biodegradability in the ground, in composting facilities, and also in biogas plants, and improved extraction capability of useful contents.

1. A device for introducing high voltage into a substrate that contains biological material, comprising two or more applicators simultaneously having different polarities, by which a measured quantity of electrical high voltage flows to change the substrate.

2. The device according to claim 1, wherein the distance between the applicators forms an intermediate space having a length from 0.5 to 20 cm.

3. The device according to claim 2, wherein the intermediate space is filled with non-conducting elements, which preferably have similar mechanical properties to the applicators.

4. The device according to claim 3, wherein the non-conducting elements are elastic.

5. The device according to claim 3, wherein the non-conducting elements are arranged so densely that it is not possible to obtain direct visual contact between the applicators even during operation, to preferably prevent flashover sparks and the deposit of conductive substrate parts.

6. The device according to claim 1, wherein the applicators are made from static, sweeping or rotating metal vanes, brushes, ridges or plates, which are arranged with two polarities on top of and/or beside each other.

7. The device according to claim 1, wherein the applicators include rotating two- or thee-winged applicator arms, folding applicator arms or brushes with or without horizontal or vertical epicyclic rotation in order to brush as completely as possible around round objects as they travel past.

8. The device according to claim 1, wherein the applicators are arranged on applicator carriers, to which further applicators or mechanical/physical devices are attached.

9. The device according to claim 1, wherein the applicators have one or more output-limited individual modules, each with an independent high voltage generator and current and voltage controller to deliver the high voltage and the associated current flows in metered amounts and control same.

10. The device according to claim 1, wherein the applicators are mounted directly on a central transport module, preferably such as a tractor, are guided loosely by a central transport module or move autonomously as self-propelled vehicles.

11. A method for using the device according to claim 1, wherein cut plant parts or other substrates are transported between two moving, closely positioned applicators in the form of drums, brushes or belts.

12. The method according to claim 11, wherein statically stored, cut plant parts or other substrates are cut through between two or more moving, closely positioned applicators in the manner of a breaker plough.

13. The method according to claim 11, wherein the pole located closest to the plant part that is to be protected is the pole with the near-earth reference voltage.
